(19) United States
(12) Patent Application Publication
(10) Pub. No.: US 2017/0168672 A1
(43) Pub. Date: Jun. 15, 2017

(54) METHOD AND ELECTRONIC DEVICE FOR DATA UPDATING

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventors: Wenliang LI, Beijing (CN); Panying NIU, Beijing (CN); Guojian LI, Beijing (CN)

(21) Appl. No.: 15/241,511

(22) Filed: Aug. 19, 2016

Related U.S. Application Data
(63) Continuation of application No. PCT/CN2016/089232, filed on Jul. 7, 2016.

(30) Foreign Application Priority Data
Dec. 10, 2015 (CN) 201510919041.5

(51) Int. Cl. G06F 3/0485; G06F 7/50

(52) U.S. Cl. CPC G06F 3/0485; G06F 7/50

(57) ABSTRACT

The present invention discloses a method and an apparatus for data updating, wherein the method includes: receiving a target count value that has been counted, and acquiring a current count value that is displayed currently; determining a place to be updated in the current count value, wherein, a value on the place to be updated in the current count value is different from a value on the same place in the target count value; and scrolling, one by one, the value on the place to be updated in the current count value to the value on the same place in the target count value, such that the current count value displayed currently is updated to the target count value. When data is updated by the method for data updating according to the invention, a user may intuitively see the change of a value on the place updated currently, thereby a problem that the current count value is directly replaced by the target count value as a whole and the user cannot perceive the update may be avoided.

### CROSS-REFERENCE TO RELATED APPLICATION

This application is a continuation of International PCT Patent Application No. PCT/CN2016/089232, filed Jul. 7, 2016 (attached hereto as an Appendix), and claims benefit/priority of Chinese patent application No. 201510919041.5, filed with the State Intellectual Property Office of China on Dec. 10, 2015, which are all incorporated herein by reference in entirety.

### TECHNICAL FIELD

The present disclosure relates to the field of Internet technologies, and in particular, to a method for data updating and an electronic device.

### BACKGROUND

It goes without saying that counting the number of on-line users plays a very important role. By counting on-line users, a website administrator may know the number of current users, then observe the performance of a program according to the number of users, so that the attraction of a website or the efficiency of a website program may be known intuitively.

After counting on-line users, in prior art, the counting result is usually displayed directly, that is, a historical counting data will be directly replaced with a new counting data. For example, in a display of on-line users of a live broadcast, the number of users at a previous moment is 3456, and the number of users at the next moment is 3256, then the data will be changed directly from 3456 to 3256. As a result, during the change of data, the administrator cannot intuitively perceive the change of data, or even cannot observe the change of data when the data contains multiple digits and one digit therein is modified.

### SUMMARY

In order to overcome the problem in prior art, the embodiments of the disclosure provides a method for data updating and an electronic device.

According to a first aspect of the embodiments of the disclosure, there provides a method for data updating, including:

receiving a target count value that has been counted, and acquiring a current count value that is displayed currently;

determining a place to be updated in the current count value, wherein, a value on the place to be updated in the current count value is different from a value on the same place in the target count value; and

scrolling, one by one, the value on the place to be updated in the current count value to the value on the same place in the target count value, such that the current count value displayed currently is updated to the target count value.

According to a second aspect of the embodiments of the present disclosure, there provides a non-transitory computer-readable storage medium storing computer-readable executable instructions that are configured to carry out any one of the above method for data updating according to the disclosure.

According to a third aspect of the embodiments of the present disclosure, there provides an electronic device that includes: at least one processor and a memory for storing instructions that are executable by the at least one processor, wherein the instructions are configured to carry out any one of the above method for data updating according to the disclosure.

The technical solutions according to the embodiments of the disclosure have the following beneficial effects:

in the method for data updating according to the embodiments of the disclosure, when at least one place of a received target count value has a value that is different from that in the current count value, the different value in the current count value may be scrolled, one by one, to the value on the same place in the target count value. Moreover, no matter what scrolling mode is chosen, during each scrolling, only one numeral value will be scrolled according to the magnitude of the numeral. Thus, for a certain place to be updated, during updating, the scrolling of a numeral may be seen, thereby it may be known that the value on the place to be updated is being changed.

Therefore, When data is updated by the method for data updating according to the disclosure, a user may intuitively see the change of a value on the place updated currently, thereby a problem that the current count value is directly replaced by the target count value as a whole and the user cannot perceive the update may be avoided.

It should be understood that, the general description above and the detailed description below are merely exemplary and illustrative, rather than limiting the disclosure.

### BRIEF DESCRIPTION OF THE DRAWINGS

The drawings here, which are incorporated into the disclosure and form a part thereof, show some embodiments consistent with the disclosure and serve to explain the principles of the disclosure together with the disclosure.

In order to illustrate more clearly the technical solutions of the embodiments of the disclosure or of the prior art, the drawings needed in the description of the embodiments or the prior art will be briefly introduced below. Apparently, the drawings in the description below merely show some embodiments of the disclosure, and other drawings may also be obtained by one of ordinary skills in the art according to these drawings without creative work.

FIG. 1 is a flow chart of a method for data updating according to one exemplary embodiment;

FIG. 2 is a detailed flow chart of Step S103 in FIG. 1;

FIG. 3 is a detailed flow chart of Step S104 in FIG. 1;

FIG. 4 is another detailed flow chart of Step S104 in FIG. 1;

FIG. 5 is a structural representation of an electronic device for data updating according to one exemplary embodiment;

FIG. 6 is a structural representation of a place-to-be-updated determination module in FIG. 5;

FIG. 7 is a structural representation of a digital value updating modulein FIG. 5; and

FIG. 8 is another structural representation of the digital value updating modulein FIG. 5; and

FIG. 9 is a diagram illustrating a hardware structure of an electronic device for carrying out the method for data updating according to an embodiment of the disclosure.

### DETAILED DESCRIPTION

Exemplary embodiments, with the examples thereof being shown in the drawings, will be illustrated in detail here. When the description below refers to the drawings, the same numeral in different drawings represents the same or similar element, unless otherwise expressed. The implementation modes described in the following exemplary embodiments do not represent all the implementation modes consistent with the disclosure. Instead, they merely show examples of the device and the method consistent with some aspects of the disclosure as described in detail in the claims appended.

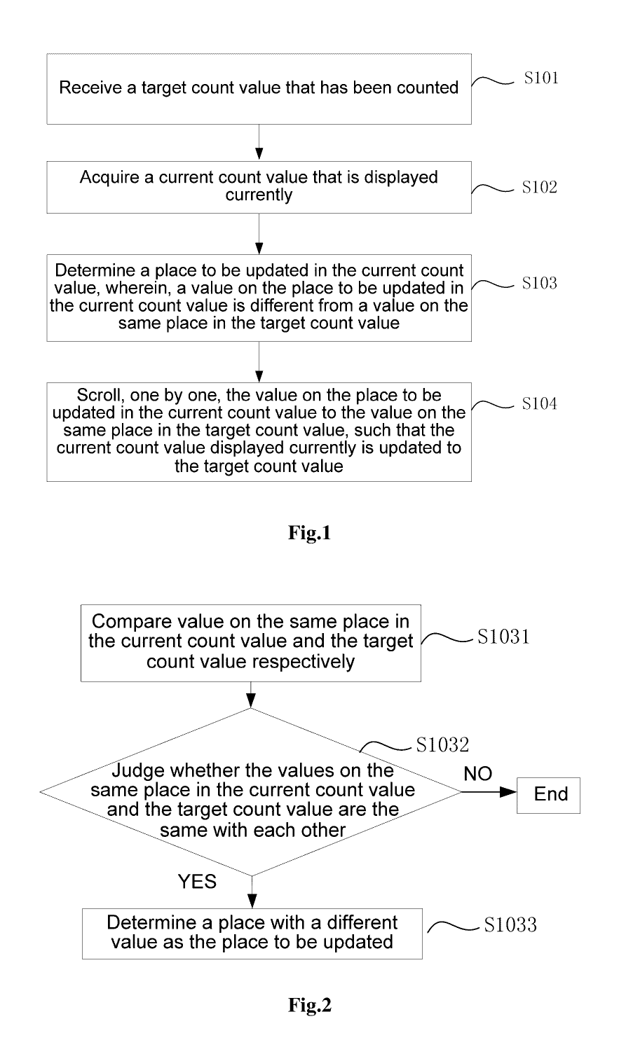

FIG. 1 is a flow chart of a method for data updating according to one exemplary embodiment. As shown in FIG. 1, the method may include the steps of:

In Step S101: a target count value that has been counted is received.

In the embodiment of the disclosure, the target count value is the value to be displayed at the next moment, i.e., the count value for updating, and the target count value may be a numerical value counted by a server or a value sent by other servers, such as an operator server, after counting.

No matter the target count value is generated by the server itself or is sent by other operator servers, it always has an identification for indicating that the value is a target count value, thus in the embodiment of the disclosure, after a value is received, the identification corresponding to the value may be extracted, and then it may be determined whether a target count value is received according to the identification.

In Step S102: a current count value that is displayed currently is acquired.

After a target count value is obtained, it further needs to acquire the current count value displayed currently. This is mainly because that the target count value is the value to be displayed at the next moment; if the target count value is the same as the current count value, the value displayed currently may be unchanged; however, if the target count value is not the same as the current count value, the value displayed currently needs to be adjusted, so that the adjusted value will be the target count value, thereby the target count value may be displayed at the next moment.

In Step S103: a place to be updated in the current count value is determined.

When the current count value is updated, various modes may be employed. Wherein, in one mode, no matter whether the values in the same places in the current count value and the target count value are the same or not, a replacement will occur on all of the places in the current count value according to the target count value; in another mode, replacement will only occur on a place whose value is different in the current count value and the target count value.

As the efficiency in the mode where replacement occurs on all places will be lowered greatly, in one embodiment of the disclosure, the process may be carried out in the second mode. Therefore, in this step, it needs to first determine, in the current count value, the places be updated; here, the values in these places are different for the current count value and the target count value; for example, the current data count value is 11326, and the target count value is 11427, then the places to be updated include ones place and hundreds place, and other places do not need to be updated because the digital values thereon are the same.

In the embodiment of the disclosure, during determination of a place to be updated in current count value, each place digit in the current count value may be compared with the place digit on the corresponding place of the target count value; once they are different, it may be determined that this place is a place to be updated. In the embodiment of the disclosure, digit place refers to ones place, hundreds place, thousands place or ten-thousands place, etc.

In Step S104: when a value on the place to be updated is different in the current count value and the target count value, the value on each place to be updated in the current count value will, one by one, be scrolled to the value on the same place in the target count value, such that the current count value displayed currently is updated to the target count value.

When the place to be updated is determined in the above Step S103, it means that only the values on the place to be updated need to be updated in the current count value. In this step, the values on the places to be updated in the current count value may be scrolled to the values on the same places in the target count value in a sequence of Arabic numerals one by one. For example: 1) if the value on the place to be updated in the current count value is 2 and the value on the same place in the target count value is 8, the one-by-one scrolling mode will be as follows: the value will be scrolled from numeral 2 to numeral 3 and then to numeral 4, and in this way to numeral 8; 2) if the value on the place to be updated in the current count value is 8 and the value on the same place in the target count value is 2, in this case, it may be determined that the numeral after numeral 9 is 0, then the one-by-one scrolling mode will be as follows: the value will be scrolled from numeral 8 to numeral 9 and then to numeral 0, and in this way to numeral 2; 3) if the value on the place to be updated in the current count value is 2 and the value on the same place in the target count value is 7, in this case, it may be determined that the numeral after numeral 0 is 9, then the one-by-one scrolling mode will be as follows: the value will be scrolled from numeral 2 to numeral 1 and then to numeral 0, and in this way to numeral 7.

After the values on all the places to be updated in the current count value have been updated, the current count value is updated to the target count value.

In the method for data updating according to the embodiment of the disclosure, when at least one place of a received target count value has a value that is different from that in the current count value, the different value in the current count value may be scrolled, one by one, to the value on the same place in the target count value. Moreover, no matter what scrolling mode is chosen, during each scrolling, only one numeral value will be scrolled according to the magnitude of the numeral. Thus, for a certain place to be updated, during updating, the scrolling of a numeral may be seen, thereby it may be known that the value on the place to be updated is being changed.

Therefore, when data are updated by employing the method for data updating according to the disclosure, a user may intuitively see the change of a value on the place updated currently, thereby a problem that the current count value is directly replaced by the target count value as a whole and the user cannot perceive the update may be avoided.

In one embodiment of the disclosure, as shown in FIG. 2, the Step S103 in the above embodiment shown in FIG. 1 may include the steps of:

In Step S1031: values on the same places in the current count value and the target count value are compared respectively.

Considering the fact that the current count value and the target count value may have different digit capacity, in the embodiment of the disclosure, a value on a place which contains no digit may be considered as zero. For example:

comparison may take place by subtraction or division.

In Step S1032: it is judged whether the values on the same places in the current count value and the target count value are the same with each other.

When comparison takes place by subtraction, it may judge whether the values are the same by judging whether the difference obtained via subtraction is zero; if the difference is zero, it indicates that the two values for subtraction are the same; otherwise, it indicates that the two values for subtraction are not the same. When comparison takes place by division, it may judge whether the values are the same by judging whether the quotient obtained after division is zero; if the quotient is zero, it indicates that the two values for division are the same; otherwise, it indicates that the two values for division are not the same.

When the values on the place to be updated are not the same for the current count value and the target count value, it turns to Step S1033; otherwise, the process ends.

In Step S1033: a place with a different value is determined as the place to be updated.

By this embodiment, it may rapidly and accurately determine the values on which places in the current count value need to be updated.

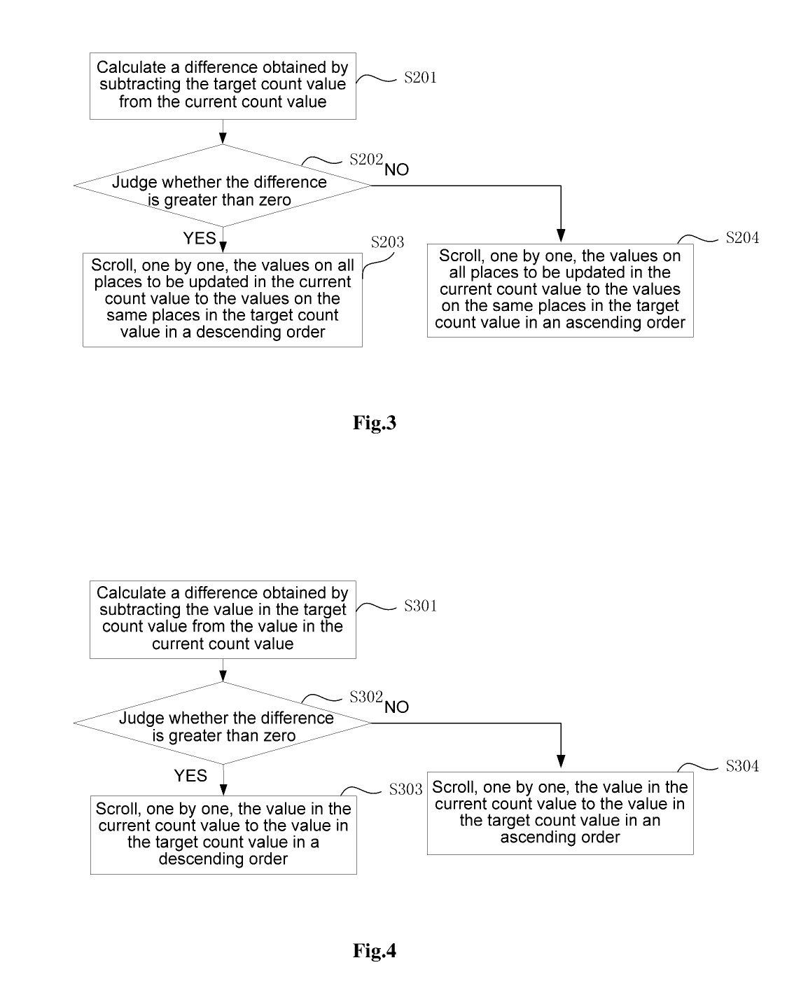

In another embodiment of the disclosure, as shown in FIG. 3, the Step S104 shown in FIG. 1 may include:

In Step S201: a difference obtained by subtracting the target count value from the current count value is calculated.

In Step S202: it is judged whether the difference is greater than zero.

When the difference is greater than zero, it turns to Step S203; otherwise, it turns to Step S204.

In Step S203: the values on all places to be updated in the current count value are scrolled to the values on the same places in the target count value, one by one, in a descending order.

When the difference is greater than zero, it indicates that the current count value is greater than the target count value; for example, the value of the current count value is 345, and the value of the target count value is 123. In such a case, during scrolling, the value on each place to be updated in the current count value will be scrolled, place by place, in a descending order. Wherein, for numeral 9, the next numeral will be 0 in the mode from-large-to-small.

In Step S204: the values on all places to be updated in the current count value are scrolled to the values on the same places in the target count value, one by one, in an ascending order.

When the difference is less than zero, it indicates that the value of the current count value is less than the value of the target count value; for example, the value of the current count value is 123, and the value of the target count value is 345. In such a case, during scrolling, the value on each place to be updated in the current count value is scrolled, place by place, in an ascending order. Wherein, for numeral 0, the next numeral will be 9 in the mode from-small-to-large.

In the embodiment of the disclosure, during an update of digital values, only the magnitudes of the current count value and the target count value are considered; consequently, when the target count value is greater than the current count value, the values on all the places to be updated will be all consistently scrolled in a downward direction, and when the target count value is less than the current count value, the values on all the places to be updated will be all consistently scrolled in an upward direction. Therefore, a user may determine the relationship of magnitude between the target count value and the current count value simple by the scrolling direction of the digital values.

In another embodiment of the disclosure, as shown in FIG. 4, for the same place to be updated, the Step S104 shown in FIG. 1 may include:

In Step S301: a difference obtained by subtracting the target count value from the current count value is calculated.

In Step S302: it is judged whether the difference is greater than zero.

When the difference is greater than 0, it turns to Step S303; otherwise, it turns to Step S304.

In Step S303: the values in the current count value are scrolled to the values in the target count value, one by one, in a descending order.

When the difference is greater than zero, it indicates that the values on the places to be updated in the current count value is greater than that in the target count value. In such a case, during scrolling, the value on each place will be scrolled, place by place, in a descending order. Wherein, for numeral 0, the next numeral will be 9 in the mode from-large-to-small.

In Step S304: the values in the current count value are scrolled to the values in the target count value, one by one, in an ascending order.

When the difference is less than zero, it indicates that the values on the places to be updated in the current count value is less than that in the target count value. In such a case, during scrolling, the value on each place will be scrolled, place by place, in an ascending order. Wherein, for numeral 9, the next numeral will be 0 in the mode from-small-to-large.

For the detailed scrolling mode in the embodiment of the disclosure, reference may be made to the description of FIG. 3, and no detailed description will be given again here.

On the basis of the above embodiments of the disclosure shown in FIG. 3 and FIG. 4, the method may further include the steps of:

in the scrolling mode from-large-to-small, scrolling the values on the places to be updated in a page-down way one by one; and

in the scrolling mode from-small-to-large, scrolling the values on the places to be updated in a page-up way one by one.

By adding a page-up or page-down operation, a dynamic effect may be provided during the change of the numerical values, so that a user may observe the change of numerals more intuitively.

On the basis of the above embodiments of the disclosure shown in FIG. 3 and FIG. 4, the method may further include the steps of:

in the scrolling mode from-large-to-small, scrolling the values on the places to be updated in a scroll-down way one by one; and

in the scrolling mode from-small-to-large, scrolling the values on the places to be updated in an scroll-up way one by one.

By adding a scroll-up or scroll-down operation, a dynamic effect may be provided during the change of the numerical values, so that a user may observe the change of numerals more intuitively.

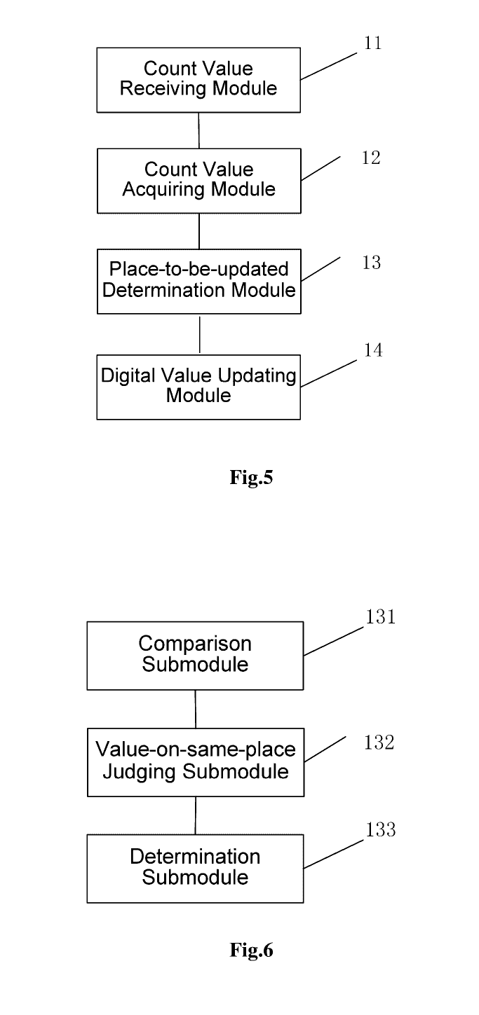

FIG. 5 is a structural representation of an electronic device for data updating according to one exemplary embodiment. As shown in FIG. 5, the electronic device may include:

a count value receiving module 11, configured for receiving a target count value that has been counted.

In the embodiment of the disclosure, the target count value is the value to be displayed at the next moment, i.e., the count value for updating, and the target count value may be a numerical value counted by a server or a value sent by other servers, such as an operator server, after counting.

No matter the target count value is generated by the server itself or is sent by other operator servers, it always has an identification for indicating that the value is a target count value, thus in the embodiment of the disclosure, after a value is received, the identification corresponding to the value may be extracted, and then it may be determined whether a target count value is received according to the identification.

a count value acquiring module 12, configured for acquiring a current count value that is displayed currently.

After a target count value is obtained, it further needs to acquire the current count value displayed currently. This is mainly because that the target count value is the value to be displayed at the next moment; if the target count value is the same as the current count value, the value displayed currently may be unchanged; however, if the target count value is not the same as the current count value, the value displayed currently needs to be adjusted, so that the adjusted value will be the target count value, thereby the target count value may be displayed at the next moment.

a place-to-be-updated determination module 13, configured for determining a place to be updated in the current count value.

When the current count value is updated, various modes may be employed. Wherein, in one mode, no matter whether the values in the same places in the current count value and the target count value are the same or not, a replacement will occur on all of the places in the current count value according to the target count value; in another mode, replacement will only occur on a place whose value is different in the current count value and the target count value.

As the efficiency in the mode where replacement occurs on all places will be lowered greatly, in one embodiment of the disclosure, the process may be carried out in the second mode. Therefore, in this step, it needs to first determine, in the current count value, the places be updated; here, the values in these places are different for the current count value and the target count value; for example, the current data count value is 11326, and the target count value is 11427, then the places to be updated include ones place and hundreds place, and other places do not need to be updated because the digital values thereon are the same.

In the embodiment of the disclosure, during determination of a place to be updated in current count value, each place digit in the current count value may be compared with the place digit on the corresponding place of the target count value; once they are different, it may be determined that this place is a place to be updated. In the embodiment of the disclosure, digit place refers to ones place, hundreds place, thousands place or ten-thousands place, etc.

a digital value updating module 14, configured for, when the values on the places to be updated are different in the current count value and the target count value, scrolling, one by one, digital values on each place to be updated in the current count value to the values on the same place in the target count value, such that the current count value displayed currently may be updated to the target count value.

When the place-to-be-updated determination module 13 determines the place to be updated, it indicates that only the value on the place to be updated needs to be updated in the current count value. In this step, the values on the places to be updated in the current count value may be scrolled to the values on the same places in the target count value in a sequence of Arabic numerals one by one. For example: 1) if the value on the place to be updated in the current count value is 2 and the value on the same place in the target count value is 8, the one-by-one scrolling mode will be as follows: the value will be scrolled from numeral 2 to numeral 3 and then to numeral 4, and in this way to numeral 8; 2) if the value on the place to be updated in the current count value is 8 and the value on the same place in the target count value is 2, in this case, it may be determined that the numeral after numeral 9 is 0, then the one-by-one scrolling mode will be as follows: the value will be scrolled from numeral 8 to numeral 9 and then to numeral 0, and in this way to numeral 2; 3) if the value on the place to be updated in the current count value is 2 and the value on the same place in the target count value is 7, in this case, it may be determined that the numeral after numeral 0 is 9, then the one-by-one scrolling mode will be as follows: the value will be scrolled from numeral 2 to numeral 1 and then to numeral 0, and in this way to numeral 7.

After the values on all the places to be updated in the current count value have been updated, the current count value is updated to the target count value.

In the electronic device for data updating according to the embodiment of the disclosure, when at least one place of a received target count value has a value that is different from that in the current count value, the different value in the current count value may be scrolled to the value on the same place in the target count value. Moreover, no matter what scrolling mode is chosen, during each scrolling, only one numeral value will be scrolled according to the magnitude of the numeral. Thus, for a certain place to be updated, during updating, the scrolling of a numeral may be seen, thereby it may be known that the value on the place to be updated is being changed.

Therefore, when the electronic device for data updating according to the disclosure is employed for data updating, a user may intuitively see the change of a value on the place updated currently, thereby a problem that the current count value is directly replaced by the target count value as a whole and the user cannot perceive the update may be avoided.

In another embodiment of the disclosure, as shown in FIG. 6, the place-to-be-updated determination module 13 in the embodiment shown in FIG. 5 includes:

a comparison submodule 131, configured for comparing values on the same places in the current count value and the target count value respectively.

Considering the fact that the current count value and the target count value may have different digit capacity, in the embodiment of the disclosure, a value on a place which contains no digit may be considered as zero. For example:

comparison may take place by subtraction or division.

a value-on-same-place judging submodule 132, configured for judging whether the values on the same places in the current count value and the target count value are the same with each other.

When comparison takes place by subtraction, it may judge whether the values are the same by judging whether the difference obtained via subtraction is zero; if the difference is zero, it indicates that the two values for subtraction are the same; otherwise, it indicates that the two values for subtraction are not the same. When comparison takes place by division, it may judge whether the values are the same by judging whether the quotient obtained after division is zero; if the quotient is zero, it indicates that the two values for division are the same; otherwise, it indicates that the two values for division are not the same.

a determination submodule 133, configured for determining a place with a different value as the place to be updated when the values on the place to be updated are not the same in the current count value and the target count value.

By this embodiment, it may rapidly and accurately determine the values on which places in the current count value need to be updated.

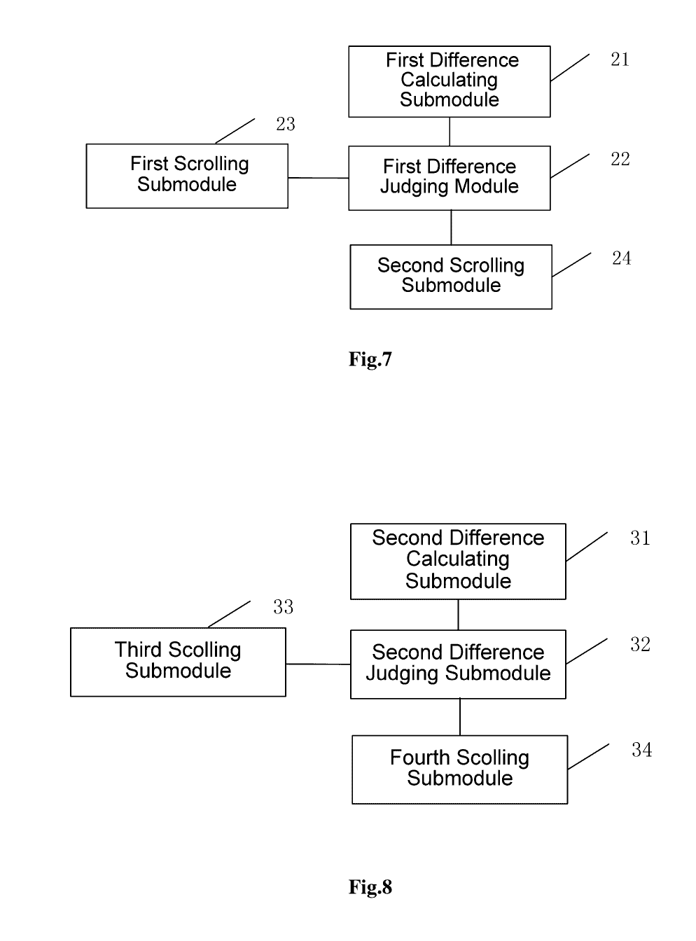

In another embodiment of the disclosure, as shown in FIG. 7, the digital value updating module 14 in the embodiment shown in FIG. 5 includes:

a first difference calculating submodule 21, configured for calculating a difference obtained by subtracting the target count value from the current count value;

a first difference judging module 22, configured for judging whether the difference is greater than zero;

a first scrolling submodule 23, configured for scrolling the values on all places to be updated in the current count value to the values on the same places in the target count value, one by one, in a descending order when the difference is greater than zero;

When the difference is greater than zero, it indicates that the current count value is greater than the target count value; for example, the value of the current count value is 345, and the value of the target count value is 123. In such a case, during scrolling, the value on each place to be updated in the current count value will be scrolled, place by place, in a descending order. Wherein, for numeral 9, the next numeral will be 0 in the mode from-large-to-small.

a second scrolling submodule 24, configured for scrolling the values on all places to be updated in the current count value to the values on the same places in the target count value, one by one, in an ascending order when the difference is less than zero;

When the difference is less than zero, it indicates that the value of the current count value is less than the value of the target count value; for example, the value of the current count value is 123, and the value of the target count value is 345. In such a case, during scrolling, the value on each place to be updated in the current count value is scrolled, place by place, in an ascending order. Wherein, for numeral 0, the next numeral will be 9 in the mode from-small-to-large.

In the embodiment of the disclosure, during an update of digital values, only the magnitudes of the current count value and the target count value are considered; consequently, when the target count value is greater than the current count value, the values on all the places to be updated will be all consistently scrolled in a downward direction, and when the target count value is less than the current count value, the values on all the places to be updated will be all consistently scrolled in an upward direction. Therefore, a user may determine the relationship of magnitude between the target count value and the current count value simple by the scrolling direction of the digital values.

In another embodiment of the disclosure, as shown in FIG. 8, the digital value updating module 14 in the embodiment shown in FIG. 5 includes:

a second difference calculating submodule 31, configured for calculating, for the same place to be updated, a difference obtained by subtracting the digital value in the target count value from the digital value in the current count value;

a second difference judging submodule 32, configured for judging whether the difference is greater than zero;

a third scrolling submodule 33, configured for scrolling values in the current count value to the values in the target count value, one by one, in a descending order when the difference is greater than 0;

When the difference is greater than zero, it indicates that the values on the places to be updated in the current count value is greater than that in the target count value. In such a case, during scrolling, the value on each place will be scrolled, place by place, in a descending order. Wherein, for numeral 0, the next numeral will be 9 in the mode from-large-to-small.

a fourth scrolling submodule 34, configured for scrolling values in the current count value to the values in the target count value, one by one, in an ascending order when the difference is less than 0;

When the difference is less than zero, it indicates that the values on the places to be updated in the current count value is less than that in the target count value. In such a case, during scrolling, the value on each place will be scrolled, place by place, in an ascending order. Wherein, for numeral 9, the next numeral will be 0 in the mode from-small-to-large.

For the detailed scrolling mode in the embodiment of the disclosure, reference may be made to the description of FIG. 7, and no detailed description will be given again here.

The embodiments of the present disclosure provide a non-transitory computer storage medium storing computer executable instructions that are configured to carry out a method for data updating according to any one of the above method embodiments.

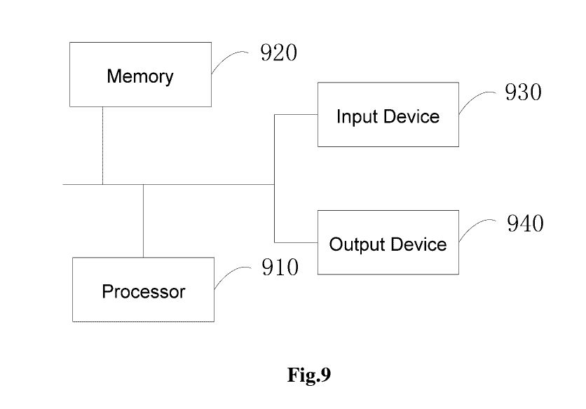

FIG. 9 is diagram illustrating a hardware structure of an electronic device for carrying out the method fordata updating according to an embodiment of the disclosure. As shown in FIG. 9, the electronic device includes:

at least one processor 910 and a memory 920, wherein only one processor 910 is illustratively shown in FIG. 9.

The electronic device executing the method for data processing may also include: an input device 930 and an output device 940.

The processor 910, memory 920, input device 930 and output device 940 may be connected via a bus or other means, wherein a connecting bus is illustratively shown in FIG. 9.

The memory 920, as a non-volatile computer-readable storage medium, may be used to store non-volatile software programs, non-volatile computer-readable executable programs and modules, such as the program commands/modules corresponded to the method for data updating according to the embodiments in the present disclosure (for example, the count value receiving module 11, the count value acquiring module 12, the place-to-be-updated determination module 13, and the digital value updating module 14 illustrated in FIG. 5). The processor 910, by running non-volatile software programs, commands and modules stored in the memory 920, performs various functional applications and data processing of the server, i.e., carries out the method for data updating according to the above embodiments in the present disclosure.

The memory 920 may include a program storage area and a data storage area, wherein the program storage area may be used to store application programs needed by an operating system or by at least one function, and the data storage area may be used to store data created by running the device for amplifying a video image, and the like. Moreover, the memory 920 may include a high speed random access memory, and also may include a non-volatile memory, such as at least one disk memory, flash memory, or other non-volatile solid state memory. According to some embodiments, the memory 920 may optionally include memories that are remotely setup with respect to the processor 910, and these remote memories may be connected to the device for amplifying a video image via a network connection. An example of such a network includes, but not limited to, internet, intranet, local area network, mobile communication network, and a combination thereof.

The input device 930 may receive input digital or character information, and generate key signal inputs concerned with user setting and functional control of the device for amplifying a video image. The output device 940 may include displaying means such as a display screen.

The at least one module is stored in the memory 920, and, when run by the at least one processor 910, executes the method for displaying according to any one of the above method embodiments.

The above product may excite the method provided by the embodiments of the present disclosure, and has functional modules and beneficial effects corresponded to the executed method. As for technical details that are not elaborated in the present embodiments, reference can be made to the method provided by the embodiments of the present disclosure.

The electronic devices in the embodiments of the present disclosure exist in various forms, including but not limited to:

(1) mobile communication devices, characterized in having a function of mobile communication mainly aimed at providing speech and data communication, wherein such terminal includes: smart phone (such as iPhone), multimedia phone, functional phone, low end phone and the like;

(2) ultra mobile personal computer devices, which falls in a scope of personal computer, has functions of calculation and processing, and generally has characteristics of mobile internet access, wherein such terminal includes: PDA, MID and UMPC devices, such as iPad;

(3) portable entertainment devices, which can display and play multimedia contents, anc includes audio or video player (such as iPod), portable game console, E-book and intelligent toys and portable vehicle navigation devices;

(4) server, a device for providing computing service, constituted by processor, hard disc, internal memory, system bus, and the like, which has a framework similar to that of a computer, but is demanded for superior processing ability, stability, reliability, security, extendibility and manageability due to that high reliable services are desired; and

(5) other electronic devices having a function of data interaction.

The above mentioned examples for the electronic device are merely exemplary, wherein the unit illustrated as a separated component may be or may not be physically separated, the component illustrated as a unit may be or may not be a physical unit, in other words, may be either disposed in some place or distributed to a plurality of network units. All or part of modules may be selected as actually required to realize the objects of the present disclosure. Such selection may be understood and implemented by ordinary skill in the art without creative work.

According to the description in connection with the above embodiments, it can be clearly understood by ordinary skill in the art that various embodiments can be realized by means of software in combination with necessary universal hardware platform, and certainly, may further be realized by means of hardware. Based on such understanding, the above technical solutions in substance or the part thereof that makes a contribution to the prior art may be embodied in a form of a software product which can be stored in a computer-readable storage medium, such as ROM/RAM, magnetic disk and compact disc, and includes several instructions for allowing a computer apparatus (which may be a personal computer, a server, a network device or the like) to execute the methods described in various embodiments or some parts thereof.

Finally, it should be stated that, the above embodiments are merely used for illustrating the technical solutions of the present disclosure, rather than limiting them. Although the present disclosure has been illustrated in details in reference to the above embodiments, it should be understood by ordinary skill in the art that some modifications can be made to the technical solutions of the above embodiments, or part of technical features can be substituted with equivalents thereof. Such modifications and substitutions do not cause the corresponding technical features to depart in substance from the spirit and scope of the technical solutions of various embodiments of the present disclosure.

1. A method for data updating applied in an electronic device, comprising:
receiving a target count value that has been counted, and acquiring a current count value that is displayed currently;
determining a place to be updated in the current count value, wherein, a value on the place to be updated in the current count value is different from a value on the same place in the target count value; and
scrolling, one by one, the value on the place to be updated in the current count value to the value on the same place in the target count value, such that the current count value displayed currently is updated to the target count value.

2. The method according to claim 1, wherein the step of determining a place to be updated in the current count value comprises:
comparing value on the same place in the current count value and the target count value respectively;
judging whether the values on the same place in the current count value and the target count value are the same with each other; and
determining the place as the place to be updated when the value on the place in the current count value is different from the value on the same place in the target count value.

3. The method according to claim 1, wherein the step of scrolling, one by one, the value on the place to be updated in the current count value to the value on the same place in the target count value comprises:
calculating a difference obtained by subtracting the target count value from the current count value;
judging whether the difference is greater than zero;
scrolling, one by one, the values on all places to be updated in the current count value to the values on the same places in the target count value in a descending order, when the difference is greater than zero; and
scrolling, one by one, the values on all places to be updated in the current count value to the values on the same places in the target count value in an ascending order, when the difference is less than zero.

4. The method according to claim 1, wherein the step of scrolling, one by one, the value on the place to be updated in the current count value to the value on the same place in the target count value comprises:
for the same place to be updated, calculating a difference obtained by subtracting the value in the target count value from the value in the current count value;
judging whether the difference is greater than zero;
scrolling, one by one, the value in the current count value to the value in the target count value in a descending order, when the difference is greater than 0; and
scrolling, one by one, the value in the current count value to the value in the target count value in an ascending order, when the difference is less than 0.

5. The method according to claim 3, further comprising:
scrolling the values on the places to be updated in a page-down way one by one when the values are scrolled in a descending order; and
scrolling the values on the places to be updated in a page-up way one by one when the values are scrolled in an ascending order.

6. The method according to claim 3, further comprising:
scrolling the values on the places to be updated in a scroll-down way one by one when the values are scrolled in a descending order; and
scrolling the values on the places to be updated in a scroll-up way one by one when the values are scrolled in an ascending order.

7. A non-transitory computer-readable storage medium storing computer-readable executable instructions that, when executed by an electronic device, cause the electronic device to:
receive a target count value that has been counted, and acquire a current count value that is displayed currently;
determine a place to be updated in the current count value, wherein, a value on the place to be updated in the current count value is different from a value on the same place in the target count value; and
scroll, one by one, the value on the place to be updated in the current count value to the value on the same place in the target count value, such that the current count value displayed currently is updated to the target count value.

8. The non-transitory computer-readable storage medium according to claim 7, wherein the instructions to determine a place to be updated in the current count value cause the electronic device to:
compare value on the same place in the current count value and the target count value respectively;
judge whether the values on the same place in the current count value and the target count value are the same with each other; and
determine the place as the place to be updated when the value on the place in the current count value is different from the value on the same place in the target count value.

9. The non-transitory computer-readable storage medium according to claim 7, wherein the instructions to scroll, one by one, the value on the place to be updated in the current count value to the value on the same place in the target count value cause the electronic device to:
calculate a difference obtained by subtracting the target count value from the current count value;
judge whether the difference is greater than zero;
scroll, one by one, the values on all places to be updated in the current count value to the values on the same places in the target count value in a descending order, when the difference is greater than zero; and
scroll, one by one, the values on all places to be updated in the current count value to the values on the same places in the target count value in an ascending order, when the difference is less than zero.

10. The non-transitory computer-readable storage medium according to claim 7, wherein the instructions to scroll, one by one, the value on the place to be updated in the current count value to the value on the same place in the target count value cause the electronic device to:
for the same place to be updated, calculate a difference obtained by subtracting the value in the target count value from the value in the current count value;
judge whether the difference is greater than zero;
scroll, one by one, the value in the current count value to the value in the target count value in a descending order, when the difference is greater than 0; and
scroll, one by one, the value in the current count value to the value in the target count value in an ascending order, when the difference is less than 0.

11. The non-transitory computer-readable storage medium according to claim 9, wherein the electronic device is further caused to:
scroll the values on the places to be updated in a page-down way one by one when the values are scrolled in a descending order; and
scroll the values on the places to be updated in a page-up way one by one when the values are scrolled in an ascending order.

12. The non-transitory computer-readable storage medium according to claim 9, wherein the electronic device is further caused to:
scroll the values on the places to be updated in a scroll-down way one by one when the values are scrolled in a descending order; and
scroll the values on the places to be updated in a scroll-up way one by one when the values are scrolled in an ascending order.

13. An electronic device, comprising:
at least one processor; and
a memory communicably connected with the at least one processor and for storing instructions executable by the at least one processor, wherein execution of the instructions by the at least one processor causes the at least one processor to:
receive a target count value that has been counted, and acquire a current count value that is displayed currently;
determine a place to be updated in the current count value, wherein, a value on the place to be updated in the current count value is different from a value on the same place in the target count value; and
scroll, one by one, the value on the place to be updated in the current count value to the value on the same place in the target count value, such that the current count value displayed currently is updated to the target count value.

14. The electronic device according to claim 13, wherein the execution of the instructions to determine a place to be updated in the current count value causes the at least one processor to:
compare value on the same place in the current count value and the target count value respectively;
judge whether the values on the same place in the current count value and the target count value are the same with each other; and
determine the place as the place to be updated when the value on the place in the current count value is different from the value on the same place in the target count value.

15. The electronic device according to claim 13, wherein the execution of the instructions to scroll, one by one, the value on the place to be updated in the current count value to the value on the same place in the target count value causes the at least one processor to:
calculate a difference obtained by subtracting the target count value from the current count value;
judge whether the difference is greater than zero;
scroll, one by one, the values on all places to be updated in the current count value to the values on the same places in the target count value in a descending order, when the difference is greater than zero; and
scroll, one by one, the values on all places to be updated in the current count value to the values on the same places in the target count value in an ascending order, when the difference is less than zero.

16. The electronic device according to claim 13, wherein the execution of the instructions to scroll, one by one, the value on the place to be updated in the current count value to the value on the same place in the target count value causes the at least one processor to:
for the same place to be updated, calculate a difference obtained by subtracting the value in the target count value from the value in the current count value;
judge whether the difference is greater than zero;
scroll, one by one, the value in the current count value to the value in the target count value in a descending order, when the difference is greater than 0; and
scroll, one by one, the value in the current count value to the value in the target count value in an ascending order, when the difference is less than 0.

17. The electronic device according to claim 15, wherein the at least one processor is further caused to:
scroll the values on the places to be updated in a page-down way one by one when the values are scrolled in a descending order; and
scroll the values on the places to be updated in a page-up way one by one when the values are scrolled in an ascending order.

18. The electronic device according to claim 15, wherein the at least one processor is further caused to:
scroll the values on the places to be updated in a scroll-down way one by one when the values are scrolled in a descending order; and
scroll the values on the places to be updated in a scroll-up way one by one when the values are scrolled in an ascending order.

19. The method according to claim 4, further comprising:
scrolling the values on the places to be updated in a page-down way one by one when the values are scrolled in a descending order; and
scrolling the values on the places to be updated in a page-up way one by one when the values are scrolled in an ascending order.

20. The method according to claim 4, further comprising:
scrolling the values on the places to be updated in a scroll-down way one by one when the values are scrolled in a descending order; and
scrolling the values on the places to be updated in a scroll-up way one by one when the values are scrolled in an ascending order.
